(19) United States
(12) Patent Application Publication
(10) Pub. No.: US 2013/0275532 A1
(43) Pub. Date: Oct. 17, 2013

(54) Electronic Message Content Party Restriction System and Method

(71) Applicant: VAPORSTREAM INCORPORATED, Chicago, IL (US)

(72) Inventors: Amit Jindas Shah, Chicago, IL (US); Jamie T. Gallagher, South Burlington, VT (US); Peter Mojica, Cornelius, NC (US)

(73) Assignee: VaporStream Incorporated, Chicago, IL (US)

(21) Appl. No.: 13/864,930

(22) Filed: Apr. 17, 2013

Related U.S. Application Data
(60) Provisional application No. 61/625,087, filed on Apr. 17, 2012.

(51) Int. Cl. H04L 12/58

(52) U.S. Cl. CPC H04L 51/00
USPC 709/206

(57) ABSTRACT

Electronic messaging system and method with a determination of message content information that includes a restricted indication of a sender and/or a recipient. A message content that includes a restricted indication of a sender and/or recipient may be rejected. A rejected message content may be limited in deliverability from a sender's computer. A rejected message content may also prompt a warning and/or be modifiable to allow for transmission.

### RELATED APPLICATION DATA

This application claims the benefit of priority of U.S. Provisional Patent Application Ser. No. 61/625,087 filed Apr. 17, 2012, and titled “Electronic Message Content Party Restriction System and Method,” which is incorporated by reference herein in its entirety.

### FIELD OF THE INVENTION

The present invention generally relates to the field of electronic messaging. In particular, the present invention is directed to an electronic message content party restriction system and method.

### BACKGROUND

Electronic messages typically combine message content with identifying information regarding the sender of the message and/or the recipient of the message. The identifying information may occur in the header of the electronic message. Header information includes the recipient address, date and/or time associated with the message, and other information. Having header information coupled to a message content may allow a third party to log, intercept, or otherwise access the electronic message and associate the message content with the sender and/or recipient of the message. This may be undesirable in certain situations. Services, such as those described in U.S. Pat. No. 7,610,345, reduce the traceability of an electronic message in part by separating the message content from the header information.

A sender may also include information identifying the sender and/or the recipient in the body of the message content (e.g., by typing the sender and/or recipient name directly into the subject matter of the message content). In such a situation, separating the header from the message content would still leave identifying information about the sender and/or recipient in the message body. There is a demand for an improved system and method for reducing the traceability of electronic messages.

### SUMMARY OF THE DISCLOSURE

In one implementation, a computer-implemented method of communicating an electronic message from a sender to a recipient is provided. The method includes identifying the sender of the electronic message; identifying one or more recipients of the electronic message; receiving from the sender a message content at a message content user interface of a computing device; determining if a restricted indication of the sender or any of the one or more recipients is included in the message content received from the sender; and rejecting the message content if the message content includes the restricted indication.

In another implementation, a machine readable hardware storage medium containing machine executable instructions implementing a method of communicating an electronic message from a sender to a recipient is provided. The instructions include a set of instructions for identifying the sender of the electronic message; a set of instructions for identifying one or more recipients of the electronic message; a set of instructions for receiving from the sender a message content at a message content user interface of a computing device; a set of instructions for determining if a restricted indication of the sender or any of the one or more recipients is included in the message content received from the sender; and a set of instructions for rejecting the message content if the message content includes the restricted indication.

In still another implementation, a computer-implemented method of communicating an electronic message from a sender to a recipient, the method comprising: receiving a recipient address from a sender at a first user interface on a first computing device; receiving a message content from the sender at a second user interface on the first computing device; and rejecting the message content if the message content includes an indication of the sender or the recipient.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates one example of a computing environment for electronic messaging;

FIG. 2 illustrates another example of a computing environment for electronic messaging;

FIG. 3 illustrates one exemplary implementation of a method of electronic messaging;

FIG. 4 illustrates another exemplary implementation of a method of electronic messaging;

FIG. 5 illustrates one example of a message entry user interface;

FIG. 6 illustrates another example of a message entry user interface;

FIG. 7 illustrates yet another example of a message entry user interface;

FIG. 8 illustrates one exemplary implementation of a system for limiting the inclusion of information that identifies a recipient and/or sender of an electronic message; and

FIG. 9 illustrates one example of a computing device.

### DETAILED DESCRIPTION

Electronic messaging allows a sending user to send a message electronically to one or more recipient users (e.g., from one computer to another computer). An electronic message typically includes header information and message content information. Example header information includes, but is not limited to, information that uniquely identifies a sending user, information that uniquely identifies a recipient user, a date and/or time associated with the electronic message (e.g., a date and/or time of creation and/or deliver), and any combinations thereof. Example information that may uniquely identify a user includes, but is not limited to, an electronic messaging address (e.g., an email address), a display name, a system login name, an alias identifier that may be correlated to a user (e.g., via a crossover table association of a system), an image representing a user, an actual name of a sender, an actual name of a recipient, a nickname of a sender, a nickname of a recipient, and any combinations thereof.

The current disclosure provides an electronic messaging system and method that limits the inclusion of information that would identify the sender of a message and/or a recipient of the message in a message content portion of the electronic message. One exemplary benefit to limiting identifying information in message content includes preventing linking a recipient and/or sender to the subject matter in a message content (e.g., where the message content has been separated from header information, such as in a recordless system as discussed below). In one example, a message content includes the body of the message. Message content may also include one or more file attachments. Message content may also include a subject line. It is contemplated that a subject line may also be included in header information. In the discussion below, it is contemplated that the message content may include the subject line in some examples (e.g., when the subject line is considered part of the message content).

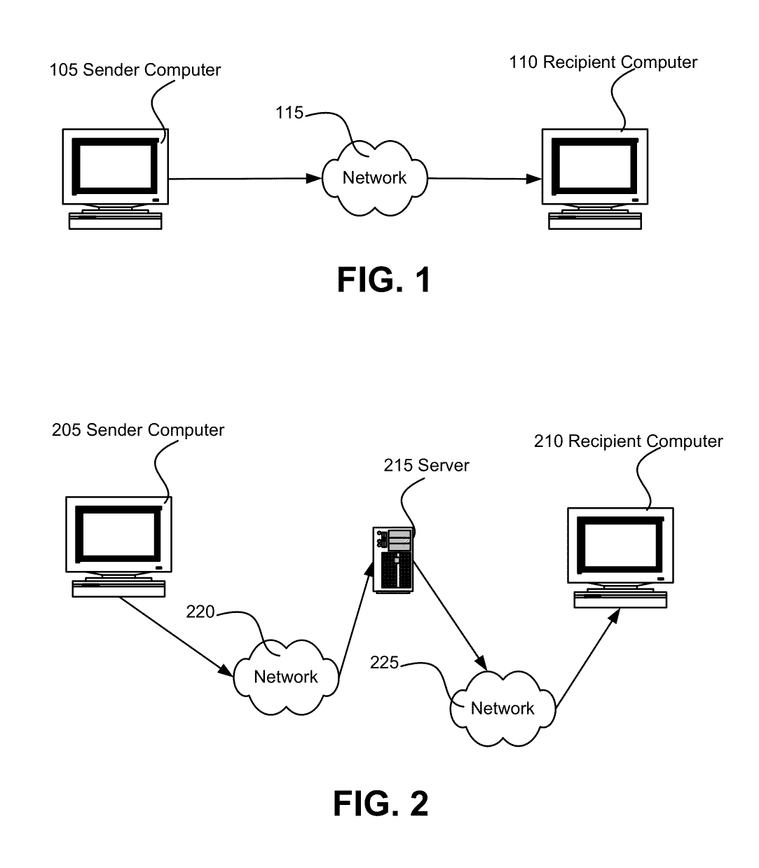

FIG. 1 illustrates one example of a typical computing environment for electronic messaging. A sender computer 105 may be utilized to compose an electronic message that is to be sent to a recipient user that may utilize recipient computer 110 to view the electronic message. Example computers include, but are not limited to, a personal computer; a workstation computer; a server computer; a laptop computer; a handheld device; a mobile device (e.g., a mobile telephone, a smartphone, a tablet computer, a personal digital assistant (PDA)); another device capable of executing instructions for composing an electronic message, viewing an electronic message, transmitting an electronic message and/or other aspects of an electronic message discussed herein; and any combinations thereof. FIG. 1 shows computer 105 in communication with computer 110 via a network 115. Example networks include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network may employ a wired and/or wireless mode of communication. An electronic messaging system may be deployed across one or more computers connected via one or more networks. Example electronic messaging systems include, but are not limited to, an email system, an electronic text messaging system, a recordless messaging system (such as the reduced traceability electronic messaging system described in U.S. Pat. No. 7,610,345 and titled “Reduced Traceability Electronic Messaging System and Method” and/or U.S. patent application Ser. No. 13/447,932, filed Apr. 16, 2012, and titled “Reduced Traceability Electronic Messaging System and Method”, each of which is incorporated herein by reference in their entireties), and any combinations thereof. A system and/or method of the present disclosure (e.g., one that includes limiting the presence of identifying information of a sending and/or recipient user from the message content) may be utilized in any of a variety of electronic messaging environments, including those described in these two incorporated documents.

In one example, a system and/or method that limits the presence of identifying information of a sender and/or a recipient in message content can be utilized with a recordless messaging system in which the header information is separated from the message content. Such a system and method is disclosed in the incorporated documents discussed above. Separation of header information and message content can occur in a variety of ways including, but not limited to, separating an input display for a recipient address from an input display for a message content (e.g., on a sending user's computer), allowing only one of header information or message content to be displayed on a sending user's computer display at a time (e.g., separating input display portions, blocking/obscuring one input portion while the other is visible), allowing only one of header information or message content to be displayed on a recipient user's computer display at a time (e.g., separating display portions, blocking/obscuring one display portion while another is visible), storing a header component separately from a message content component (e.g., date stored separately on sending computer, server computer, recipient computer), transmitting a header component separately from a message content component such that the two components are not transmitted from one computer to another together (e.g., from a sending computer to a recipient computer, from a sending computer to a server computer, from a server computer to a recipient computer), and any combinations thereof.

FIG. 2 illustrates another example of a typical computing environment for electronic messaging including a sender computer 205 and a recipient computer 210 connected via a server computer 215 and networks 220 and 225. Server computer 215 is shown as a single server computer. It is contemplated that server computer 215 may include any number of server computers (e.g., servers local to each other and/or distributed via one or more networks). In an example of an environment such as the environment in FIG. 2, a sending user may compose an electronic message at computer 205. The message can be communicated to server 215 (e.g., upon completion of all or part of the message, such as the separate communication of header and message content described in U.S. Pat. No. 7,610,345, the description of which is incorporated herein by reference in its entirety). The message may be stored at server 215 until a recipient user is ready to retrieve the message (e.g., using recipient computer 210).

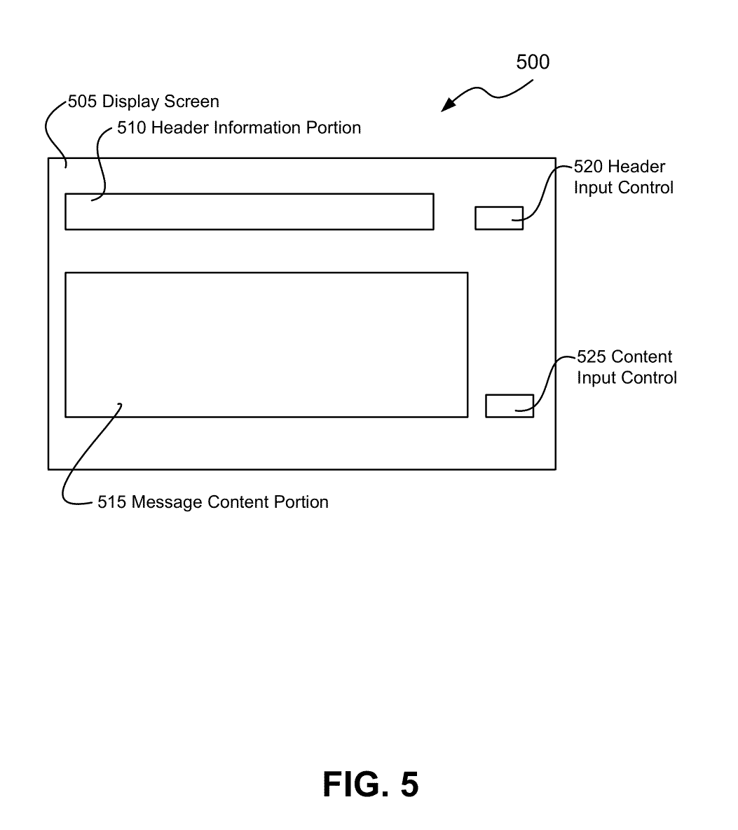

A sending user typically will utilize a user interface to enter/compose an electronic message. Various user interfaces are contemplated and will be configurable by a person of ordinary skill in light of the current disclosure. Example user interfaces are discussed further below (e.g., with respect to FIGS. 5 to 7.

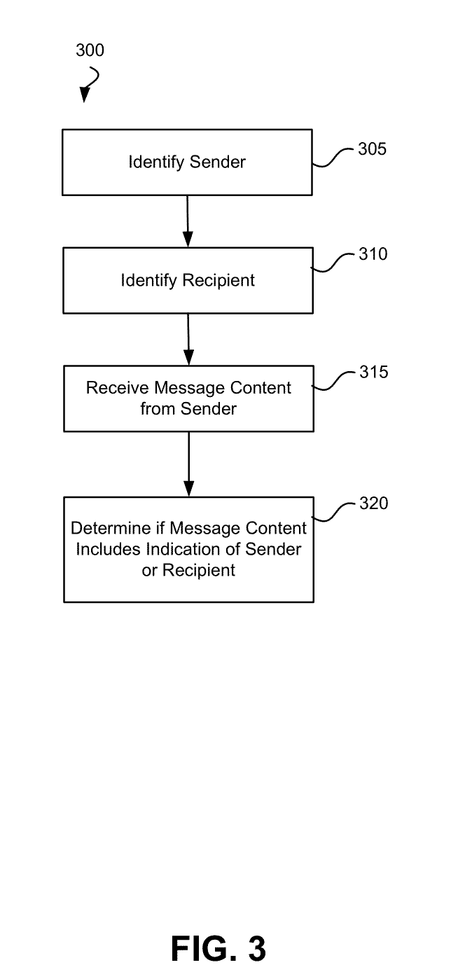

FIG. 3 illustrates one exemplary implementation of a method 300 of electronic messaging. At step 305, a sender of an electronic message is identified. Example ways to identify a sender include, but are not limited to, using information obtained from a login to an electronic messaging system, using a session ID (e.g., a session ID established between a sending user computer and another computing device, such as a server computer managing an electronic messaging system), utilizing information input to a data entry field (e.g., data entered by the sender user in composing the electronic message, such as via a “from” field).

At step 310, the identity of one or more recipients of the electronic message is identified. It is noted that throughout this disclosure the term “a recipient” may be used to represent the possibility of the singular and/or the plural for recipients. For example, an electronic message may be directed to a single user, multiple users, to a group of users (e.g., a user group), etc. Example ways to identify an identity of a recipient user include, but are not limited to, utilizing information entered by the sending user to address the message (e.g., via a text entry field, via a pull down list of one or more possible recipients, using a selected image of a recipient user, etc.).

At step 315, a message content is received from the sender user. In one example, a sender computer may include client software that works with the individual hardware and operating system of the computer to allow entry of information, including the message content, of an electronic message. Message content may be input into one or more message content entry portions of a user interface.

At step 320, the message content is reviewed to determine if information that identifies a sender and/or a recipient is included in the message content. In one exemplary aspect, if such information is included for example, the message content may be rejected, allowed to be delivered, modified prior to delivery, and any combinations thereof. The determination may occur at one or more locations of the messaging system. Example locations for determining if sender and/or recipient identifying information is included in message content include, but are not limited to, at the sender computer (e.g., using client software programmed to make a determination), at a server computer that receives the message content (e.g., directly via a network interface accessed by a sender user computer, after electronic transmission from a sender user computer, etc.), at a recipient computer, and any combination thereof.

Determining if information in a message content can be used to identify a user can be done in a variety of ways. Example ways to determine if information included in message content can be used to identify a user (e.g., a sender and/or a recipient) include, but are not limited to, comparing the information in the message content to user information stored in a memory (e.g., at the sender computer, at a server computer, at a recipient computer, etc.), comparing information in the message content to information input in a “from” field of a user interface, comparing information in the message content to information input in a “to” and/or “recipient” field of a user interface, comparing the information in the message content for an exact match to an identity of a user, comparing the information in the message content for common misspellings of an identity of a user, comparing the information in the message content for common soundings of an identity of a user, comparing information in the message content for common nicknames for an identity of a user, comparing information in the message content against alias names for the identity of a user that are manually entered into a database (e.g., aliases entered at time of entering a user in an electronic messaging system, such as those known as name alternatives for a person, nicknames, etc.), comparing information in the message content against real nicknames and aliases of a user, comparing information in the message content for obfuscations of a user identity (e.g., identifying a name variant that includes additional characters, such as dashes, asterisks, or other marks within the name (determining that “J-o-h-n” is a comparison for “John”)), comparing one way hash values (e.g., irreversible hash values) for data values (e.g., comparing hash values for recipient and/or sender identities that are sent back from server computer after server computer receives header information from a sender computer, comparing hash values at server side, and/or comparing hash values at time of entry by sender), using a security level code that is assigned to the message content that rates a level of comparison of the message content (e.g., such a code may be communicated to a server from a user computer for processing and comparison, the code can be used to determine if a message should be rejected or allowed to be transmitted), and any combinations thereof.

The determining if message content includes identifying information of a recipient and/or a sender can be at any time (e.g., a time that allows action to limit the inclusion of such information, such as by rejecting the information, allowing the information, and modifying the information). Example timings for determining if message content includes identifying information of a recipient and/or a sender include, but are not limited to, as a sender enters message content (e.g., via monitoring the data entry at the sender computer, such as via programmed client software having access to the identity information from steps 305 and/or 310), periodic comparisons during entry of message content, at notification of an event by a computer (e.g., a keystroke event notice, a mouse/pointer device event notice), continuous comparison (e.g., using a while(1) loop), at actuation of a user control of a message entry interface (e.g., at completion of message content entry, at completion of electronic message entry, at a time of desire by sender user to check message content, etc.), upon receipt of message content at a server computer, prior to saving message content to a memory of an electronic messaging system (e.g. a memory of a server, a memory on a sender computer, a recipient computer), at a copy/paste event (e.g., a user attempts to copy and paste identifying information into a message content), and any combinations thereof.

As discussed above, after determining if a message content includes information identifying a user, the message may be rejected, allowed to be delivered (e.g., unaltered (such as when no identifying information is included or when a predetermined low amount of information is included) and/or altered (examples of which will be discussed below). Rejection of a message may be triggered by identifying information in the message content. Example ways to reject a message include, but are not limited to, preventing further data entry by a sender user (e.g., when information is determined at the time of entry by the sender user), providing a graphical indication to the sender user that the identifying information is rejected, providing an audio indication to the sender user that the identifying information is rejected, providing a pop-up window indication (e.g., with a message indicating that the user cannot enter that name in message content), providing a haptic indication to a user that identifying information is included message content (e.g., a vibration, such as a vibration of a mobile device), providing a visual indication to a user that identifying information is included in message content (e.g., an LED light indication on a mobile device), providing an indication at time of data entry, providing an indication of rejection at time of user actuation of a user interface control (e.g., at time of completion of entry of message content, at time of completion of entry of electronic message, at time of actuation of another control), providing a rejection after a server computer receives the message content being rejected, highlighting text and/or images that are rejected in message content, underlining text and/or images that are rejected in message content, providing an indication (e.g., a graphical indication, a textual explanation, etc.) in the body of a message content returned by a server after rejection to an inbox of a sender user, and any combinations thereof. A rejected message content may be prevented from delivery to a recipient. A rejected message content may also be prevented from storage, further display on a display device of a computer, or other restriction that will prevent the rejected message content from being retrievable with message content. A rejected message content may be returned to a sender to correct the inclusion of identifying information of a recipient and/or sender (e.g., by removing the identifying content). A user interface control can be included in a returned message that allows a user to actuate the control and automatically cause the removal of all determined identifying information of a recipient and/or a sender. After correction, a sender may resend message content.

A message content may also be allowed to be delivered after information identifying a recipient and/or sender are determined to be included in the message content. In one example, such delivery may be combined with one or more of the above described rejection indications. Example ways to handle message content that includes identifying information while allowing delivery include, but are not limited to, automatically redacting identifying information in message content, automatically replacing identifying information with non-identifying information (e.g., different names from those of the rejected recipient/sender), automatically removing identifying information from message content, and any combinations thereof. After handling message content may be delivered (e.g., to a server computer, to a recipient, etc.). Example ways of redacting include, but are not limited to, replacing rejected content with a textual character (e.g., an asterisk or an “x”), replacing rejected content with a graphical element (e.g., a blackout of rejected material), replacing rejected content text characters with a different number of non-identifying character(s) (e.g., randomly assigning different character numbers), and any combinations thereof.

In one exemplary implementation, a rejection of a message content may be overridden. Example ways to override a rejection include, but are not limited to, providing settings for a sender that exempt that sender from rejection rules, providing settings for a recipient that exempt that recipient from rejection rules, allowing a recipient to receive a warning message prior to receiving a message content including identifying information of a recipient and/or sender, and any combinations thereof. Example warning messages to a recipient include, but are not limited to, an audio alert, a graphical indication (e.g., a different color tone for a rejected message in a recipient's in-box), a haptic indication (e.g., vibration), a visual indication (e.g., LED light indication), and any combinations thereof. A warning message may include an actuatable display control (e.g., an “override” button) that allows the user to override the rejection. In one example, an overridden rejection may be transmitted to a server computer and/or to a recipient.

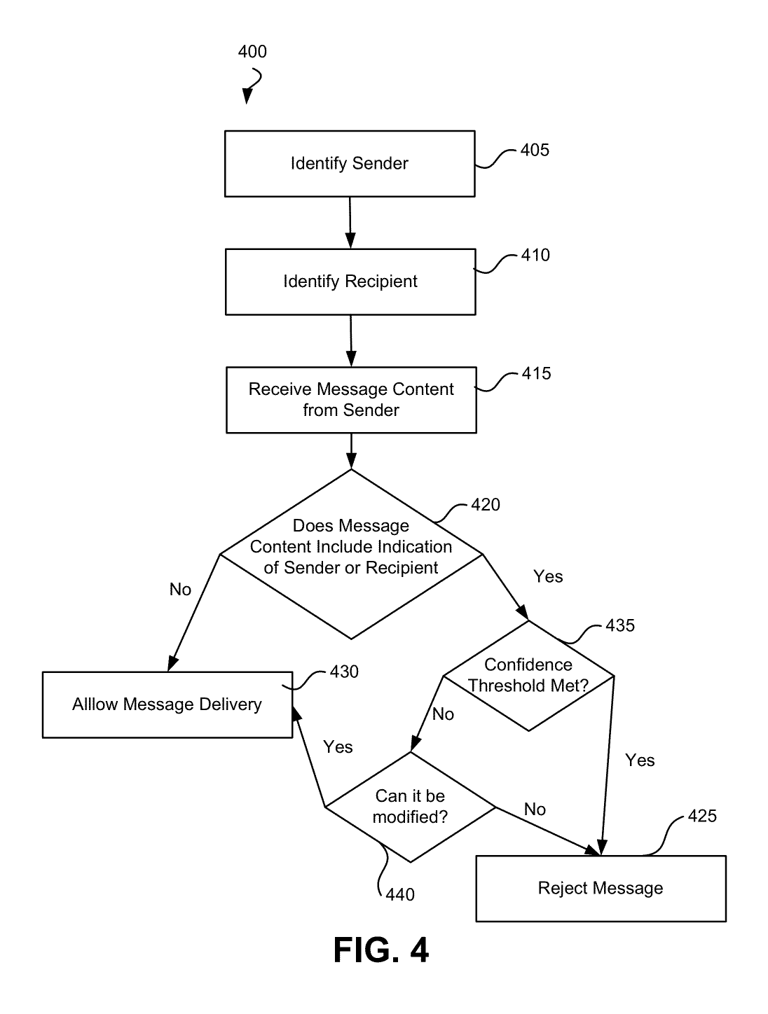

FIG. 4 illustrates another exemplary implementation of a method 400 of electronic messaging. Method 400 includes similar aspects as those of method 300 discussed above, except as indicated below. At step 405, an identity of a sender of an electronic message is determined. At step 410, an identity of a recipient of an electronic message is determined. At step 415, a message content is received from a sender of the electronic message. At step 420, the message content is reviewed to determine if it includes information that would identify the sender and/or the recipient. If the message does not include such information, the message is allowed to be delivered at step 430. If the message does include such information, the message is rejected at step 425. Optionally, if the message includes such information, the message content that is identifying of a recipient and/or sender is reviewed at step 435 to determine the severity of the identification (e.g., to determine how close the identification is, such as an exact match versus a common nickname, to determine if the identifying information can be automatically redacted, removed, modified). If the severity exceeds a predetermined threshold indicating that the message needs to be rejected (e.g., and returned to the sender), the message is rejected at step 425. If the severity does not exceed a predetermined threshold, the message content can be modified at step 440. Modification may include allowing the message to be delivered at step 430 (e.g., as discussed above with respect to rejected messages being delivered in method 300, such as by redaction, removal, etc.). Such modifications may be automatically performed prior to delivery. If modification is not possible for one or more reasons, the message is rejected at step 425.

FIG. 5 illustrates one example of a message entry user interface 500. Interface 500 includes a display screen 505 having a header information entry portion 510 (e.g., for allowing sending user to enter one or more recipient addresses) and a message content entry portion 515 for allowing entry of message content. Interface 500 also includes user interface header input control 520. Control 520 may be actuated by a sender user to indicate that the recipient address has been entered (e.g., also sending the recipient address from the sender computer). Interface 500 also includes a content input interface control 525. In one example, control 525 may be used by a user to actuate to indicate the entry of message content is complete.

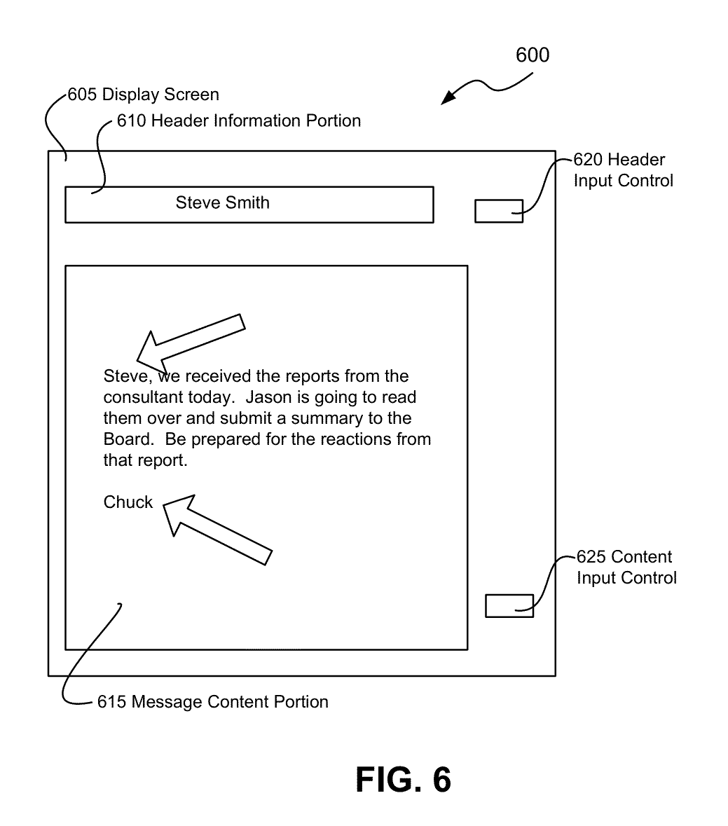

FIG. 6 illustrates another example of a message entry user interface 600. Interface 600 includes a display screen 605, a header information entry portion 610, a message content entry portion 615, and interface controls 620 and 625. Entry portion 610 includes entered data that represents a recipient of the electronic message. This data can be used to determine the identity of the recipient. Message content entry portion 615 includes textual information representing the body of the electronic message. The message content data includes the term “Steve” and the term “Chuck.” In this example, the sender of the message is a user with an actual name of “Chuck.” The message content information has been determined to include information that identifies both the sender and a recipient. An indication of rejection of the information is provided in the form of graphical arrows pointing to the identifying information. Other alternative indications of rejection are discussed above.

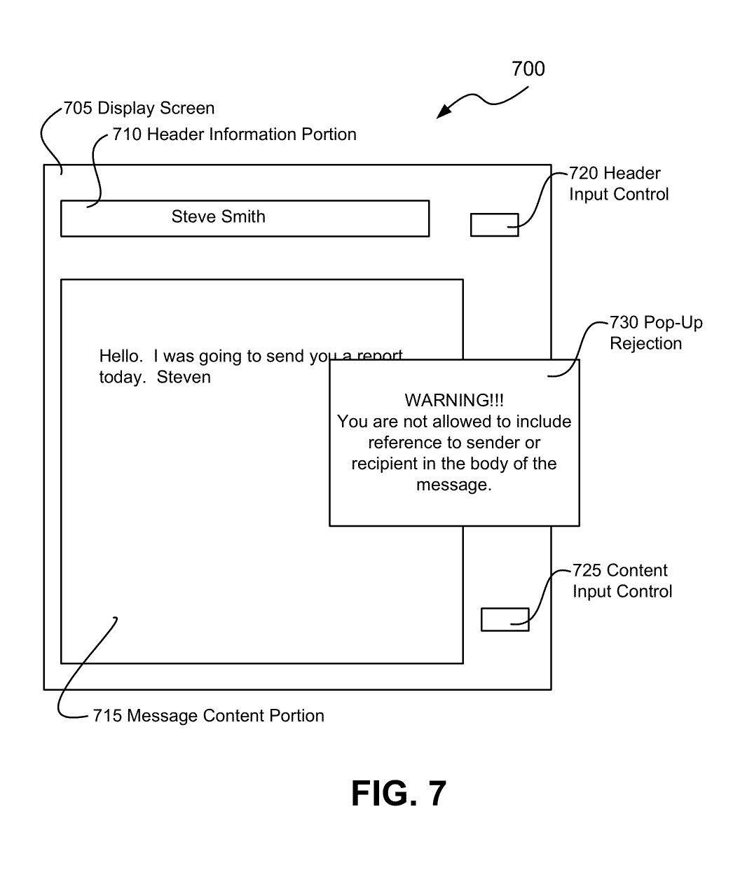

FIG. 7 illustrates yet another example of a message entry user interface 700. Interface 700 includes a display screen 705, a header information entry portion 710, a message content entry portion 715, and interface controls 720 and 725. Entry portion 710 includes entered data that represents a recipient of the electronic message. This data can be used to determine the identity of the recipient. Message content entry portion 715 includes textual information representing the body of the electronic message. In this example, real-time determination is made during the entry of the message content. As the term “Steven” is entered in entry portion 715, it is determined that this information can be identifying of the recipient “Steve Smith” (e.g., via comparison to a database having stored alias's for Steve Smith, via comparison to a database having common alias's for the name “Steve”, etc.). An indication of rejection is provided via the pop-up window 730 that provides a textual warning of the restriction of entering recipient names in the body of the message. In an alternate example, rejection 730 may also be accompanied by an user override (e.g., an actuatable display control, such as a button) to allow the user to override the rejection.

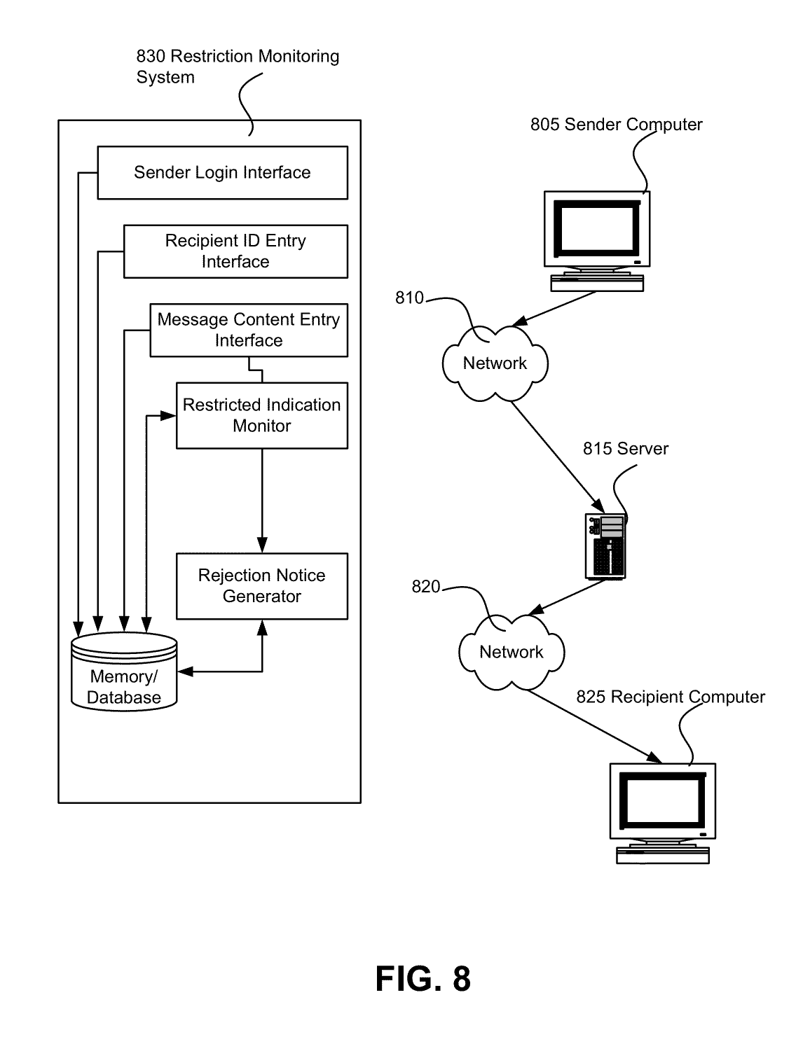

FIG. 8 illustrates an exemplary implementation of a system for limiting the inclusion of information that identifies a recipient and/or sender of an electronic message. An electronic messaging environment is shown including a sender computer 805, a network 810, a server 815, a network 820, and a recipient computer 825 (each of which may include one or more computers and/or networks). A restriction monitoring system 830 is shown. System 830 is configured to implement one or more of the functionalities of method 300 and/or method 400. Any one or more of the components of system 830 may be distributed to one or more of computer 805, server 815, and computer 825. System 830 includes a sender login interface for providing a user interface to a sender user for logging into system 830 (e.g., providing information to identify the sender). In one example, system 830 includes hardware (e.g., a display device and/or display generator) and executable instructions for providing a graphical user interface to a sender user allowing the user to enter an identifier of the user. In one aspect, information that provides an identity of the sender user may be stored in one or more memory elements. System 830 includes a recipient ID entry interface configured to provide a user interface for entering information that allows delivery of an electronic message to a recipient. In one example, a recipient ID entry interface includes hardware (e.g., a display device and/or display generator) and executable instructions for providing a graphical user interface to a sender user allowing the user to enter an identifier of the recipient user. System 830 includes a message content entry interface for allowing a sender user to enter a message content to system 830. In one example, a message content entry interface includes hardware (e.g., a display device and/or display generator) and executable instructions for providing a graphical user interface to a sender user allowing the user to enter a message content. System 830 includes a restricted indication monitor for comparing message content information to identified recipient and sender information to see if information in the message content can be used to identify the recipient and/or sender. System 830 also includes a rejection notice generator for providing a rejection as discussed above (e.g., when user identifying information is determined to by in a message content, when data in a message content exceeds a predetermined threshold).

It is also contemplated that in addition to the limitation (e.g., rejection) of information that identifies a recipient and/or sender from message content, other information and/or items may be limited/rejected using similar methods and functionalities as discussed above. Example additional items that may be used to reject a message content (e.g., alone or in combination with recipient/sender identifying information) include, but are not limited to, date of creation of message, time of creation of message, objectionable (e.g., nude, pornographic) images, keywords and their synonyms (e.g., “promise” and “guarantee”), offensive words/phrases, and any combinations thereof.

It is to be noted that any one or more of the aspects and embodiments described herein may be conveniently implemented using one or more machines (e.g., one or more computing devices that are utilized as a user computing device for an electronic document, one or more server devices, such as a document server) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk (e.g., a conventional floppy disk, a hard drive disk), an optical disk (e.g., a compact disk “CD”, such as a readable, writeable, and/or re-writable CD; a digital video disk “DVD”, such as a readable, writeable, and/or rewritable DVD), a magneto-optical disk, a read-only memory “ROM” device, a random access memory “RAM” device, a magnetic card, an optical card, a solid-state memory device (e.g., a flash memory), an EPROM, an EEPROM, and any combinations thereof. A machine-readable medium, as used herein, is intended to include a single medium as well as a collection of physically separate media, such as, for example, a collection of compact disks or one or more hard disk drives in combination with a computer memory. As used herein, a machine-readable storage medium does not include a signal.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

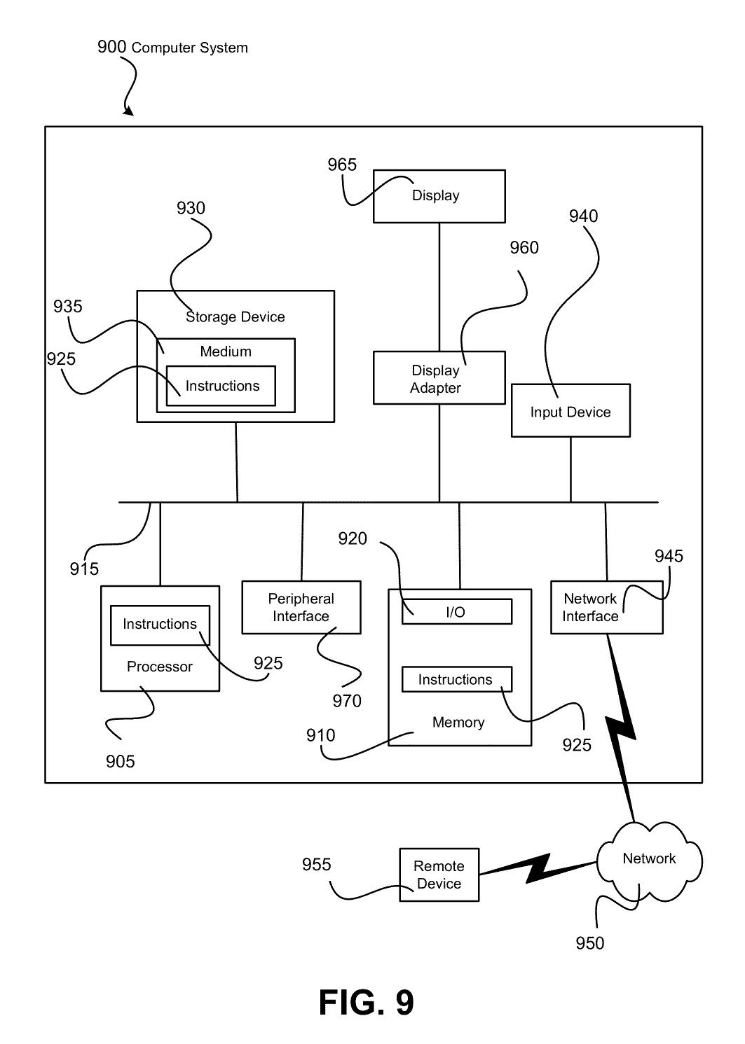

FIG. 9 shows a diagrammatic representation of one embodiment of a computing device in the exemplary form of a computer system 900 within which a set of instructions for causing the device to perform any one or more of the aspects and/or methodologies of the present disclosure may be executed. It is also contemplated that multiple computing devices may be utilized to implement a specially configured set of instructions for causing the device to perform any one or more of the aspects and/or methodologies of the present disclosure. Computer system 900 includes a processor 905 and a memory 910 that communicate with each other, and with other components, via a bus 915. Bus 915 may include any of several types of bus structures including, but not limited to, a memory bus, a memory controller, a peripheral bus, a local bus, and any combinations thereof, using any of a variety of bus architectures.

Memory 910 may include various components (e.g., machine readable media) including, but not limited to, a random access memory component (e.g., a static RAM “SRAM”, a dynamic RAM “DRAM”, etc.), a read only component, and any combinations thereof. In one example, a basic input/output system 920 (BIOS), including basic routines that help to transfer information between elements within computer system 900, such as during start-up, may be stored in memory 910. Memory 910 may also include (e.g., stored on one or more machine-readable media) instructions (e.g., software) 925 embodying any one or more of the aspects and/or methodologies of the present disclosure. In another example, memory 910 may further include any number of program modules including, but not limited to, an operating system, one or more application programs, other program modules, program data, and any combinations thereof.

Computer system 900 may also include a storage device 930. Examples of a storage device (e.g., storage device 930) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 930 may be connected to bus 915 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 930 (or one or more components thereof) may be remotely interfaced with computer system 900 (e.g., via an external port connector (not shown)). Particularly, storage device 930 and an associated machine-readable medium 935 may provide nonvolatile and/or volatile storage of machine-readable instructions, data structures, program modules, and/or other data for computer system 900. In one example, software 925 may reside, completely or partially, within machine-readable medium 935. In another example, software 925 may reside, completely or partially, within processor 905.

Computer system 900 may also include an input device 940. In one example, a user of computer system 900 may enter commands and/or other information into computer system 900 via input device 940. Examples of an input device 940 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 940 may be interfaced to bus 915 via any of a variety of interfaces (not shown) including, but not limited to, a serial interface, a parallel interface, a game port, a USB interface, a FIREWIRE interface, a direct interface to bus 915, and any combinations thereof. Input device may include a touch screen interface that may be a part of or separate from display 965, discussed further below.

A user may also input commands and/or other information to computer system 900 via storage device 930 (e.g., a removable disk drive, a flash drive, etc.) and/or a network interface device 945. A network interface device, such as network interface device 945 may be utilized for connecting computer system 900 to one or more of a variety of networks, such as network 950, and one or more remote devices 955 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 950, may employ a wired and/or a wireless mode of communication. In general, any network topology may be used. Information (e.g., data, software 925, etc.) may be communicated to and/or from computer system 900 via network interface device 945.

Computer system 900 may further include a video display adapter 960 for communicating a displayable image to a display device, such as display device 965 (e.g., for providing user access to one or more user interfaces. Examples of a display device include, but are not limited to, a liquid crystal display (LCD), a cathode ray tube (CRT), a plasma display, a light emitting diode (LED) display, and any combinations thereof. In addition to a display device, a computer system 900 may include one or more other peripheral output devices including, but not limited to, an audio speaker, a printer, and any combinations thereof. Such peripheral output devices may be connected to bus 915 via a peripheral interface 970. Examples of a peripheral interface include, but are not limited to, a serial port, a USB connection, a FIREWIRE connection, a parallel connection, and any combinations thereof.

In one exemplary implementation, a computer-implemented method of communicating an electronic message from a sender to a recipient is provided. The method includes identifying the sender of the electronic message; identifying one or more recipients of the electronic message; receiving from the sender a message content at a message content user interface of a computing device; determining if a restricted indication of the sender or any of the one or more recipients is included in the message content received from the sender; and rejecting the message content if the message content includes the restricted indication. The method may further include sending the message content from the computing device if the message content does not include an indication of the sender or any of the one or more recipients. The method may further include the message content being transmitted from the computing device separately from any header component of the electronic message. The method may further include saving the message content on a server computer if the message content does not include an indication of the sender or any of the one or more recipients. The method may further include said identifying the sender including using information from a login of the sender. The method may further include said identifying the sender including using information input by the sender in a header data entry field of a header user interface. The method may further include identifying the sender including using a session identification to determine the sender. The method may further include wherein said determining includes comparing text of the received message content includes the name of any of the one or more recipients. The method may further include wherein said determining includes referencing a database that includes multiple entries of name variants for the one or more recipients. The method may further include wherein said determining is performed at the computing device prior to transmitting the message content from the computing device. The method may further include wherein said determining occurs in response to actuation of a control of the message content user interface. The method may further include wherein said determining is performed as the sender is entering the message content into the message content user interface. The method may further include wherein said determining is performed at one or more server computers after transmitting the message content from the computing device. The method may further include wherein said rejecting includes generating a display message indicating the rejection of the message. The method may further include wherein said rejecting includes providing the sender with a notice of the rejection at the time of entry of the restricted indication.

In another exemplary implementation a computer-implemented method of communicating an electronic message from a sender to a recipient is provided. The method includes receiving a recipient address from a sender at a first user interface on a first computing device; receiving a message content from the sender at a second user interface on the first computing device; and rejecting the message content if the message content includes an indication of the sender or the recipient.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A computer-implemented method of communicating an electronic message from a sender to a recipient, the method comprising:
identifying the sender of the electronic message;
identifying one or more recipients of the electronic message;
receiving from the sender a message content at a message content user interface of a computing device;
determining if a restricted indication of the sender or any of the one or more recipients is included in the message content received from the sender; and
rejecting the message content if the message content includes the restricted indication.

2. A computer-implemented method according to claim 1, further comprising sending the message content from the computing device if the message content does not include an indication of the sender or any of the one or more recipients.

3. A computer-implemented method according to claim 2, wherein the message content is transmitted from the computing device separately from any header component of the electronic message.

4. A computer-implemented method according to claim 1, wherein said rejecting the message content includes preventing the message content from delivery to the one or more recipients.

5. A computer-implemented method according to claim 4, further comprising overriding said rejecting the message content.

6. A computer-implemented method according to claim 5, wherein said overriding includes:
providing the sender with an override control via a user interface;
receiving an indication from the override control that the sender has activated the override control; and
transmitting the message content to a server computer and/or to the one or more recipients.

7. A computer-implemented method according to claim 5, wherein said overriding includes determining that the sender and/or one or more recipients are exempted from one or more rejection rules.

8. A computer-implemented method according to claim 1, wherein said rejecting the message content includes a restriction selected from the group consisting of preventing the message content from being stored, preventing the message content from being displayed via a display device of a computer, preventing the restricted indication from being retrieved as part of the message content, and any combinations thereof.

9. A computer-implemented method according to claim 1, wherein said rejecting the message content includes allowing the message content to be transmitted to a server computer and/or one or more recipients.

10. A computer-implemented method according to claim 9, wherein said rejecting the message content further comprises a handling of a restricted indication selected from the group consisting of automatically redacting a restricted indication, automatically removing a restricted indication, automatically replacing a restricted indication with information that does not identify a sender and/or one or more recipients, and any combinations thereof.

11. A computer-implemented method according to claim 1, wherein said rejecting the message content includes a restriction selected from the group consisting of preventing further data entry by the sender, providing a graphical indication to the sender that the restricted indication is rejected, providing an audio indication to the sender that the restricted indication is rejected, providing a pop-up window indication, providing a haptic indication to the sender that the restricted indication is rejected, providing a visual indication to the sender that the restricted indication is rejected, providing an indication at time of data entry, providing an indication of rejection at time of user actuation of a user interface control of the message content user interface, providing a rejection after a server computer receives the message content being rejected, highlighting text and/or images that are rejected in message content, underlining text and/or images that are rejected in message content, providing an indication in the body of a message content returned by a server after rejection to an inbox of a sender user, and any combinations thereof.

12. A computer-implemented method according to claim 1, further comprising saving the message content on a server computer if the message content does not include an indication of the sender or any of the one or more recipients.

13. A computer-implemented method according to claim 1, further comprising transmitting the message content from the computing device if the message content does not include an indication of the sender or any of the one or more recipients.

14. A computer-implemented method according to claim 1, wherein said identifying the sender includes a use of information selected from the group consisting of using information from a login of the sender, using information input by the sender in a header data entry field of a header user interface, using a session identification to determine the sender, and any combinations thereof.

15. A computer-implemented method according to claim 1, wherein said identifying the one or more recipients includes using information entered by the sender to address the electronic message.

16. A computer-implemented method according to claim 1, wherein said determining includes a comparison selected from the group consisting of comparing information in the message content to user information stored in a memory, comparing information in the message content to information input in a “from” field of a user interface, comparing information in the message content to information input in a “to” and/or “recipient” field of a user interface, comparing the information in the message content for an exact match to an identity of a user, comparing the information in the message content for common misspellings of an identity of a user, comparing the information in the message content for common soundings of an identity of a user, comparing information in the message content for common nicknames for an identity of a user, comparing information in the message content against alias names for the identity of a user that are manually entered into a database, comparing information in the message content against real nicknames and aliases of a user, comparing information in the message content for obfuscations of a user identity, comparing one way hash values for data values, using a security level code that is assigned to the message content that rates a level of comparison of the message content, and any combinations thereof.

17. A computer-implemented method according to claim 1, wherein said determining includes referencing a database that includes multiple entries of name variants for the one or more recipients and/or sender.

18. A computer-implemented method according to claim 1, wherein said determining is performed at the computing device prior to transmitting the message content from the computing device.

19. A computer-implemented method according to claim 18, wherein said determining occurs in response to actuation of a control of the message content user interface.

20. A computer-implemented method according to claim 1, wherein said determining is performed as the sender is entering the message content into the message content user interface.

21. A computer-implemented method according to claim 1, wherein said determining is performed at one or more server computers after transmitting the message content from the computing device.

22. A machine readable hardware storage medium containing machine executable instructions implementing a method of communicating an electronic message from a sender to a recipient, the instructions comprising:
a set of instructions for identifying the sender of the electronic message;
a set of instructions for identifying one or more recipients of the electronic message;
a set of instructions for receiving from the sender a message content at a message content user interface of a computing device;
a set of instructions for determining if a restricted indication of the sender or any of the one or more recipients is included in the message content received from the sender; and
a set of instructions for rejecting the message content if the message content includes the restricted indication.

23. A machine readable hardware storage medium according to claim 22, further comprising a set of instructions for sending the message content from the computing device if the message content does not include an indication of the sender or any of the one or more recipients.

24. A machine readable hardware storage medium according to claim 23, wherein the message content is transmitted from the computing device separately from any header component of the electronic message.

25. A machine readable hardware storage medium according to claim 22, wherein said set of instructions for rejecting the message content includes a set of instructions for preventing the message content from delivery to the one or more recipients.

26. A machine readable hardware storage medium according to claim 25, further comprising a set of instructions for overriding said rejecting the message content.

27. A machine readable hardware storage medium according to claim 26, wherein said set of instructions for overriding includes:
a set of instructions for providing the sender with an override control via a user interface;
a set of instructions for receiving an indication from the override control that the sender has activated the override control; and
a set of instructions for transmitting the message content to a server computer and/or to the one or more recipients.

28. A machine readable hardware storage medium according to claim 26, wherein said set of instructions for overriding includes a set of instructions for determining that the sender and/or one or more recipients are exempted from one or more rejection rules.

29. A machine readable hardware storage medium according to claim 22, wherein said set of instructions for rejecting the message content includes a restriction selected from the group consisting of preventing the message content from being stored, preventing the message content from being displayed via a display device of a computer, preventing the restricted indication from being retrieved as part of the message content, and any combinations thereof.

30. A machine readable hardware storage medium according to claim 22, wherein said set of instructions for rejecting the message content includes a set of instructions for allowing the message content to be transmitted to a server computer and/or one or more recipients.

31. A machine readable hardware storage medium according to claim 30, wherein said set of instructions for rejecting the message content further comprises a set of instructions for handling of a restricted indication selected from the group consisting of a set of instructions for automatically redacting a restricted indication, a set of instructions for automatically removing a restricted indication, a set of instructions for automatically replacing a restricted indication with information that does not identify a sender and/or one or more recipients, and any combinations thereof.

32. A machine readable hardware storage medium according to claim 22, wherein said set of instructions for rejecting the message content includes a restriction selected from the group consisting of preventing further data entry by the sender, providing a graphical indication to the sender that the restricted indication is rejected, providing an audio indication to the sender that the restricted indication is rejected, providing a pop-up window indication, providing a haptic indication to the sender that the restricted indication is rejected, providing a visual indication to the sender that the restricted indication is rejected, providing an indication at time of data entry, providing an indication of rejection at time of user actuation of a user interface control of the message content user interface, providing a rejection after a server computer receives the message content being rejected, highlighting text and/or images that are rejected in message content, underlining text and/or images that are rejected in message content, providing an indication in the body of a message content returned by a server after rejection to an inbox of a sender user, and any combinations thereof.

33. A machine readable hardware storage medium according to claim 22, further comprising a set of instructions for saving the message content on a server computer if the message content does not include an indication of the sender or any of the one or more recipients.

34. A machine readable hardware storage medium according to claim 22, further comprising a set of instructions for transmitting the message content from the computing device if the message content does not include an indication of the sender or any of the one or more recipients.

35. A machine readable hardware storage medium according to claim 22, wherein said set of instructions for identifying the sender includes a use of information selected from the group consisting of using information from a login of the sender, using information input by the sender in a header data entry field of a header user interface, using a session identification to determine the sender, and any combinations thereof.

36. A machine readable hardware storage medium according to claim 22, wherein said set of instructions for identifying the one or more recipients includes a set of instructions for using information entered by the sender to address the electronic message.

37. A machine readable hardware storage medium according to claim 22, wherein said set of instructions for determining includes a comparison selected from the group consisting of comparing information in the message content to user information stored in a memory, comparing information in the message content to information input in a “from” field of a user interface, comparing information in the message content to information input in a “to” and/or “recipient” field of a user interface, comparing the information in the message content for an exact match to an identity of a user, comparing the information in the message content for common misspellings of an identity of a user, comparing the information in the message content for common soundings of an identity of a user, comparing information in the message content for common nicknames for an identity of a user, comparing information in the message content against alias names for the identity of a user that are manually entered into a database, comparing information in the message content against real nicknames and aliases of a user, comparing information in the message content for obfuscations of a user identity, comparing one way hash values for data values, using a security level code that is assigned to the message content that rates a level of comparison of the message content, and any combinations thereof.

38. A machine readable hardware storage medium according to claim 22, wherein said set of instructions for determining includes a set of instructions for referencing a database that includes multiple entries of name variants for the one or more recipients and/or sender.

39. A machine readable hardware storage medium according to claim 22, wherein said determining is performed at the computing device prior to transmitting the message content from the computing device.

40. A machine readable hardware storage medium according to claim 39, wherein said determining occurs in response to actuation of a control of the message content user interface.

41. A machine readable hardware storage medium according to claim 22, wherein said determining is performed as the sender is entering the message content into the message content user interface.

42. A machine readable hardware storage medium according to claim 22, wherein said determining is performed at one or more server computers after transmitting the message content from the computing device.

43. A computer-implemented method of communicating an electronic message from a sender to a recipient, the method comprising:
receiving a recipient address from a sender at a first user interface on a first computing device;
receiving a message content from the sender at a second user interface on the first computing device; and
rejecting the message content if the message content includes an indication of the sender or the recipient.
